(19) United States
(12) Patent Application Publication
(10) Pub. No.: US 2013/0310491 A1
(43) Pub. Date: Nov. 21, 2013

(54) DEGRADABLE FIBERS

(71) Applicants: Michael D. Crandall, North Oaks, MN (US); Rudolf J. Dams, Antwerp (BE); Michelle M. Hewitt, Inver Grove Heights, MN (US); Ignatius A. Kadoma, Cottage Grove, MN (US); Siegmund Papp, Woodbury, MN (US); Yong K. Wu, Woodbury, MN (US); Daniel J. Zillig, Cottage Grove, MN (US); Jay M. Jennen, Forest Lake, MN (US); Sasha B. Myers, Arden Hills, MN (US)

(72) Inventors: Michael D. Crandall, North Oaks, MN (US); Rudolf J. Dams, Antwerp (BE); Michelle M. Hewitt, Inver Grove Heights, MN (US); Ignatius A. Kadoma, Cottage Grove, MN (US); Siegmund Papp, Woodbury, MN (US); Yong K. Wu, Woodbury, MN (US); Daniel J. Zillig, Cottage Grove, MN (US); Jay M. Jennen, Forest Lake, MN (US); Sasha B. Myers, Arden Hills, MN (US)

(73) Assignee: 3M 9NNOVATIVE PROPERTIES COMPANY, St. Paul, MN (US)

(21) Appl. No.: 13/994,370

(22) PCT Filed: Dec. 8, 2011
(86) PCT No.: PCT/US11/63983

§ 371 Date: Jun. 14, 2013

Related U.S. Application Data
(60) Provisional application No. 61/423,231, filed on Dec. 15, 2010.

(51) Int. Cl. C08L 67/04

(52) U.S. Cl. CPC C08L 67/04
USPC 524/47; 525/450; 525/190; 524/58; 524/377; 264/211

(57) ABSTRACT

There is provided self-degrading fibers, and methods of making and methods of using such self-degrading fibers.

The present disclosure relates to self-degrading fibers. The present disclosure also relates to methods of making and using self-degrading fibers.

### BACKGROUND

Degradable materials have been used in various subterranean applications because of their ability to degrade and leave voids, temporarily restrict the flow of a fluid, and/or produce desirable degradation products. Poly(lactic acid) (“PLA”) has been used a degradable material because it degrades in subterranean environments after performance of a desired function or because its degradation products may perform a desired function, such as, for example, degrading an acid soluble component. Upon degradation, degradable materials may be used to leave behind voids in order to improve the permeability of a given structure. One such example is when a degradable material is used with proppant particles to create a proppant pack. When the degradable material degrades there remains a proppant pack having voids therein. Another such example is creation of voids in set cement used in subterranean environments. Other exemplary applications for degradable materials include coatings (for temporarily protecting a coated object or chemical from exposure to subterranean environments), tools or parts made out of solid masses of degradable material (for use in subterranean environments), diverting agents, bridging agents, and fluid loss control agents.

Notwithstanding the application for which the degradable material is used, controlling the degradation of the degradable material is important. For instance, a diverting agent formed from a solid particulate degradable material would be of little or no use if it degraded too quickly when placed in a portion of a subterranean formation from which diversion was desired. There exists a need for a relatively low-cost degradable fiber material for which is it possible to control degradation in various applications.

### SUMMARY

In one aspect, the present disclosure provides a self-degrading fiber comprising: (a) from about 60 weight percent to about 96 weight percent of a first material based on the total weight of the fiber, and (b) from about 4 weight percent to about 40 weight percent of a second material based on the total weight of the fiber, wherein the second material is one of a a co-oligomer comprising lactate and glycolate or a copolymer of 2-ethylhexyl acrylate and dimethylamino ethylmethacrylate.

In another aspect, the present disclosure provides a self-degrading fiber comprising a first material and a second material, wherein the fiber has a degradation level of at least 5 weight percent based on the total weight of the fiber when subjected to a temperature of about 38° C. for seven days in the presence of moisture.

In still another aspect, the present disclosure provides a self-degrading fiber comprising a first material and a second material, wherein the fiber has a degradation level of at least 5 weight percent based on the total weight of the fiber when subjected to a temperature of about 49° C. for seven days in the presence of moisture.

In yet another aspect, the present disclosure provides a method of making at least one self-degrading fiber comprising: (a) providing from about 70 weight percent to about 96 weight percent of a first material; (b) providing from about 4 weight percent to about 30 weight percent of a second material, wherein the second material is an oligomer comprising lactic acid and glycolic acid; (c) combining the first material and the second material in an extruder; (d) heating the mixture of the first material and the second material; and (e) extruding the mixture through a die head to form a fiber.

In another aspect, the present disclosure provides a method of making at least one self-degrading fiber comprising: (a) providing a first material; (b) providing a second material; (c) combining the first material and the second material in an extruder; (d) heating the mixture of the first material and the second material; and (e) extruding the mixture through a die head to form a fiber, wherein the fiber has a degradation level of at least 5 weight percent based on the total weight of the fiber when subjected to a temperature of about 38° C. for seven days in the presence of moisture.

In still another aspect, the present disclosure provides a method of making at least one self-degrading fiber comprising: (a) providing a first material; (b) providing a second material; (c) combining the first material and the second material in an extruder; (d) heating the mixture of the first material and the second material; and (e) extruding the mixture through a die head to form a fiber, wherein the fiber has a degradation level of at least 5 weight percent based on the total weight of the fiber when subjected to a temperature of about 49° C. for seven days in the presence of moisture.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term:

“a”, “an”, and “the” are used interchangeably and mean one or more; and “and/or” is used to indicate one or both stated cases may occur, for example A and/or B includes, (A and B) and (A or B). Also herein, recitation of ranges by endpoints includes all numbers subsumed within that range (e.g., 1 to 10 includes 1.4, 1.9, 2.33, 5.75, 9.98, etc.). Also herein, recitation of “at least one” includes all numbers of one and greater (e.g., at least 2, at least 4, at least 6, at least 8, at least 10, at least 25, at least 50, at least 100, etc.).

“Self-contained fiber” means a fiber composition with no additional additives or coatings, such as, for example, encapsulants.

“Self-degrading fiber” means self-contained fiber having a desired degradation level, which is defined herein as at least 5 weight percent loss based on the total weight of the self-contained fiber when subjected to moisture at 38° C. and/or 49° C. for seven days.

“Crystalline” as used in combination with polymers herein means polymers having a distinct melting point.

“Amorphous” as used in combination with polymers herein means non crystalline in that non crystalline compounds do not have a melting point, or at least no distinct melting point.

“Oligomer” means any compound having at least 4 repeating units of the same or different structure or chemical composition but having up to 1000 repeating units of the same or different structure or chemical composition.

“Polymer” means any compound having at least 1000 repeating units of the same or different structure or chemical composition.

“Copolymer” means a polymer that is derived from two or more monomeric species, including for example terpolymers, tetramers, and the like.

The first material used in the present disclosure includes, for example, degradable monomers, oligomers, and polymers, and combinations thereof. Other exemplary degradable materials include insoluble esters that are not polymerizable, such as esters including formates, acetates, benzoate esters, phthalate esters, and the like. The first material may also includes blends of any of the aforementioned options, such as polymer/polymer blends or monomer/polymer blends, which may be useful for controlling the overall self-degradation level of the degradable material. Fillers or other additives, such as, for example, particulate or fibrous fillers, may also be added to the first material.

When selecting the first material, the self-degradation rate of the degradable fiber and the resulting degradation products should be considered. Selection of the first material may depend, at least in part, on the conditions under which the self-degrading fiber made therefrom will be used. For example, moisture, temperature, pressure, oxygen, microorganisms, enzymes, pH, and the like, may impact the degradation of the first material and, thus, the degradation level of the self-degrading fibers made therefrom.

Degradation rates of polymers are at least partially dependent upon the polymer backbone structure. For example, polymers may degrade at different rates depending on the type of repetitive unit, composition, sequence, length, molecular geometry, molecular weight, morphology (e.g., crystallinity, size of spherulites, and orientation), hydrophilicity, hydrophobicity, surface area, and additives. Some exemplary degradable monomers include lactide, lactones, glycolides, anhydrides, and lactams.

With regard to lactide monomer, it should be noted that lactide exists in three different forms: stereoisomers L-lactide and D-lactide and racemic D,L-lactide (meso-lactide). The chirality of lactide units provides a means to adjust, among other things, degradation rates, as well as physical and mechanical properties. Poly-L-lactide (PLLA) is the product resulting from polymerization of L-lactide. PLLA is a semi-crystalline polymer having a crystallinity of around 37%, a glass transition temperature between 50-80° C. and a melting temperature between 173-178° C. PLLA has a relatively slow degradation rate. Polymerization of a racemic mixture of L- and D-lactides typically leads to synthesis of poly-DL-lactide (PDLLA), which is an amorphous polymer, and as such, has degradation rate that is faster than that of PLLA. Use of stereospecific catalysts can lead to heterotactic PLA which has been found to show crystallinity. The degree of crystallinity, and hence the resulting chemical and physical properties of the polymer, is controlled by the ratio of D to L enantiomers used. The stereoisomers of lactic acid may be used individually or combined in accordance with the present disclosure. Additionally, the lactic acid stereoisomers can be modified by blending high and low molecular weight poly(lactide).

The second material used in the present disclosure is one of an oligomer or a copolymer of 2-ethylhexyl acrylate and dimethylamino ethylmethacrylate. Oligomers useful in the second material disclosed herein include all of the various lactides disclosed above with regard to the first material. These oligomers are copolymerized with, for example, glycolide or other monomers like [epsilon]-caprolactone, 1,5-dioxepan-2-one, trimethylene carbonate, or other suitable monomers to obtain an oligomer with a degradation rate different than that of the first material. In one embodiment, lactic acid is copolymerized with glycolic acid to form a co-oligomer including lactate and glycolate repeating units, which can be useful as the second material in the present disclosure. In one embodiment, the weight percent of lactic acid based on the total weight of the monomers is greater than or equal to about 50 weight percent.

The second material may also include one or more additional components. These components include, but are not limited to, derivatives of oligomeric lactic acid, polyethylene glycol; polyethylene oxide; oligomeric lactic acid; citrate esters (such as tributyl citrate oligomers, triethyl citrate, acetyltributyl citrate, acetyltriethyl citrate); glucose monoesters; partially fatty acid esters; PEG monolaurate; triacetin; poly([epsilon]-caprolactone); poly(hydroxybutyrate); glycerin-1-benzoate-2,3-dilaurate; glycerin-2-benzoate-1,3-dilaurate; starch; bis(butyl diethylene glycol)adipate; ethylphthalylethyl glycolate; glycerine diacetate monocaprylate; diacetyl monoacyl glycerol; polypropylene glycol (and epoxy, derivatives thereof); polypropylene glycol)dibenzoate, dipropylene glycol dibenzoate; glycerol; ethyl phthalyl ethyl glycolate; poly(ethylene adipate)distearate; di-iso-butyl adipate; and combinations thereof.

Self-degrading fibers according to the present disclosure degrade from the inside out, both chemically and physically. Without wishing to be bound by theory, it is believed that the second material behaves as a degradation additive and initiates the degradation process by catalyzing the hydrolysis of the first material (e.g., polylactic acid). Degradation additives can be acidic or basic. Acidic degradation additives, such as for example, a co-oligomer of lactic and glycolic acids (75/25) will degrade rapidly forming an acid in-situ, respectively a mixture of glycolic acid and lactic acid, and lactic acid. Basic degradation additives, such as for example amine terminated polypropylene glycol (commercially available under the trade designation “JEFFAMINE D2000” from Huntsman Chemical, Salt Lake City, Utah) and a copolymer of 2-ethylhexyl acrylate and dimethylamino ethylmethacrylate (2-EHA/DMAEMA), allow a basic catalysis of the hydrolysis reaction and neutralization of the formed acidic species.

The first and second materials can be processed like most thermoplastics into fiber (for example using conventional melt spinning processes) and film. The first and second material are to be combined, such as for example in pellet form, in various weight ratios or weight percents. In one embodiment, the first material is present in a major amount. In one embodiment the weight percent of the first material based on the total weight of the self-degradable fiber is greater than 50 weight percent, greater than 60 weight percent, greater than 70 weight percent, greater than 80 weight percent, greater than 90 weight percent, or even greater than 95 weight percent. In some embodiments, the weight percent of the first material based on the total weight of the self-degradable fiber is greater than 50 weight percent and less than 99 weight percent. In some embodiments, the weight percent of the first material based on the total weight of the self-degradable fiber is between about 70 weight percent and about 96 weight percent. In one embodiment, the second material is present in a minor amount. In one embodiment the weight percent of the second material based on the total weight of the self-degradable fiber is less than 50 weight percent, less than 40 weight percent, less than 30 weight percent, less than 20 weight percent, less than 10 weight percent, or even less than 5 weight percent. In some embodiments, the weight percent of the second material based on the total weight of the self-degradable fiber is less than 50 weight percent and greater than 1 weight percent. In some embodiments, the weight percent of the second material based on the total weight of the self-degradable fiber is between about 4 weight percent and about 30 weight percent.

In one embodiment, the first material and second material are combined in an extruder, such as for example a 25 mm twin screw extruder (commercially available under the trade designation “Ultraglide” from Berstorff, Hannover, Germany). The extruder is then heated depending on the type of materials selected for use as the first and second material. For example, in one embodiment the extruder is heated to temperatures ranging from about 190° C. to about 230° C. In another exemplary embodiment, the extruder is heated to temperatures ranging from about 185° C. to about 230° C.

Self-degrading fibers are then prepared by extruding the heated material through a die. For example, a 0.05 cm diameter die with a 64-filament orifice and 4:1 length/diameter ratio can be used on a 19 mm single screw extruder (commercially available from Killion Laboratories, Houston, Tex.). The die and single screw extruder are typically run at a temperature above ambient conditions depending on the specific materials selected for use as the first and second material. In one embodiment, the die and single extruder are run at a temperature ranging from about 150° C. to about 170° C. In one embodiment, the die and single extruder are run at a temperature ranging from about 130° C. to about 165° C. In one embodiment, the die and single extruder are run at a temperature ranging from about 120° C. to about 165° C. In one embodiment, the die and single extruder are run at a temperature ranging from about 120° C. to about 160° C. In one embodiment, the die and single extruder are run at a temperature ranging from about 120° C. to about 145° C.

Once extruded, the resulting self-degrading fibers are cooled and drawn. Cooling can be done under ambient conditions using air or by using any known cooling techniques. Drawing can be done at various roll speeds depending on the selection of first and second materials and the desired resulting diameter of the self-degrading fibers. For example, in one embodiment, a roll speed of 250 m/min was used.

### Additives

Modifiers and other additives can be added to the self-degrading fibers disclosed herein. For example, plasticizers can be added to the presently disclosed self-degrading fibers. Plasticizers are materials which alter the physical properties of the polymer to which they are added, such as, for example, modifying the glass transition temperature of the polymer. Typically the plasticizer(s) need to be compatible with the polymer to make the effect noticeable. Plasticizer useful in the present disclosure include “in natura” (as found in nature) vegetable oil or its ester or epoxy derivative coming from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, and the like. Also synthetic materials derived from hydrocarbons such as oil or natural gas are also suitable. Examples of these materials include phthalates such as 2-ethyl hexyl phthalate, adipates such as dioctyl adipate, trimellitates such as trimethyl trimellitate, and maleates such as dioctyl maleate.

Natural fillers may also be added to the presently disclosed self-degrading fibers. Natural fillers useful in the present disclosure include lignocellulosic fillers, such as, for example, wood flour or wood dust, starches and rice husk, and the like. Other useful fillers include talc and calcium carbonate. Processing aid/dispersant can be used in the presently disclosed self-degrading fibers. Exemplary, processing aid/dispersants useful in the present disclosure include compositions with thermoplastics, such as that available under the trade designation “Struktol” (commercially available from Struktol Company of America.

Nucleants, such as, for example boron nitride or a nucleant available under the trade designation “HPN” (commercially available from Milliken) are another type of additive that can be added to the presently disclosed self-degrading fibers. Compatibilizers are another category of additives that can be used in the present disclosure. Exemplary compatibilizers include polyolefine functionalized or grafted with anhydride maleic; ionomer based on copolymer ethylene-acrylic acid or ethylene-methacrylic acid neutralized with sodium (such as those available under the trade designation “Surlyn” from DuPont). Other additives useful in the present disclosure include thermal stabilizers, such as, for example, primary antioxidant and secondary antioxidant, pigments; ultraviolet stabilizers of the oligomeric HALS type (hindered amine light stabilizer).

Self-degrading fibers according to the present disclosure may be used in any subterranean application wherein it is desirable for the self-degrading fibers to degrade, e.g., to leave voids, act as a temporary restriction to the flow of a fluid, or produce desirable degradation products. In some embodiments, self-degrading fibers according to the present disclosure are useful for subterranean applications including, but not limited to, cementing (such as, for example, regular or acid soluble cement compositions), fracturing, or gravel packing applications. In some embodiments, the presently disclosed self-degrading fibers are used in conjunction with hydraulic cement compositions and their associated applications, including, but not limited to, primary cementing, sand control, and fracturing. Self-degrading fibers according to the present disclosure may also be used in sand control applications in a permeable cement composition. Self-degrading fibers according to the present disclosure are also useful in fracturing applications, either in conjunction with any suitable fracturing fluid, including a conventional fracturing fluid that includes a base fluid and a viscosifying agent or a fracturing fluid that comprises a cement composition. The presently disclosed self-degrading fibers are also useful in a fracturing operation that does not involve a cement composition to form a proppant pack in a fracture having voids to increase its permeability. Self-degrading fibers according to the present disclosure may also be incorporated within a gravel pack composition so as to form a gravel pack down hole that provides some permeability from the degradation of the self-degrading fibers.

Following are exemplary embodiments of the present disclosure:

### Embodiment 1

A self-degrading fiber comprising:

(a) from about 60 weight percent to about 96 weight percent of a first material based on the total weight of the fiber, and

(b) from about 4 weight percent to about 40 weight percent of a second material based on the total weight of the fiber,

wherein the second material is an oligomer comprising lactate and glycolate.

### Embodiment 2

The self-degrading fiber of embodiment 1 further comprising:

(c) a plasticizer.

### Embodiment 3

The self-degrading fiber of embodiment 2 wherein the plasticizer is selected from polyethylene glycol, starch, glucose, polypropylene glycol, and combinations thereof.

### Embodiment 4

The self-degrading fiber of any preceding embodiment wherein the first material comprises at least about 70 weight percent and the second material comprises no more than 30 weight percent based on the total weight of the fiber.

### Embodiment 5

The self-degrading fiber of any preceding embodiments wherein the second material comprises at least 75 weight percent of lactate and at least 25 weight percent of glycolate.

### Embodiment 6

The self-degrading fiber of any preceding embodiments wherein the first material is amorphous.

### Embodiment 7

The self-degrading fiber of embodiment 1, 2, 3, 4 or 5 wherein the first material is crystalline.

### Embodiment 8

The self-degrading fiber of any preceding embodiment wherein the first material is a mixture of crystalline and amorphous.

### Embodiment 9

The self-degrading fiber of any preceding embodiment wherein the fiber is a self-contained fiber.

### Embodiment 10

A self-degrading fiber comprising a first material and a second material, wherein the fiber has a degradation level of at least 5 weight percent based on the total weight of the fiber when subjected to a temperature of about 38° C. for seven days in the presence of moisture.

### Embodiment 11

The self-degrading fiber of embodiment 10 wherein the second material further comprises polyethylene glycol.

### Embodiment 12

The self-degrading fiber of embodiment 10 or 11 wherein the first material is amorphous.

### Embodiment 13

The self-degrading fiber of embodiment 10 or 11 wherein the first material is crystalline.

### Embodiment 14

A self-degrading fiber comprising a first material and a second material, wherein the fiber has a degradation level of at least 5 weight percent based on the total weight of the fiber when subjected to a temperature of about 49° C. for seven days in the presence of moisture.

### Embodiment 15

The self-degrading fiber of embodiment 14 wherein the second material further comprises polyethylene glycol.

### Embodiment 16

The self-degrading fiber of embodiment 14 or 15 wherein the first material is amorphous.

### Embodiment 17

The self-degrading fiber of embodiment 14 or 15 wherein the first material is crystalline.

### Embodiment 18

A method of making at least one self-degrading fiber comprising:
(a) providing from about 70 weight percent to about 96 weight percent of a first material;
(b) providing from about 4 weight percent to about 30 weight percent of a second material, wherein the second material is an oligomer comprising lactic acid and glycolic acid;
(c) combining the first material and the second material in an extruder;
(d) heating the mixture of the first material and the second material; and
(e) extruding the mixture through a die head to form a fiber.

### Embodiment 19

The method of embodiment 18 wherein the second material further comprises polyethylene glycol.

### Embodiment 20

The method of embodiment 18 or 19 wherein the second material comprises at least 75 weight percent of lactic acid and at least 25 weight percent of glycolic acid.

### Embodiment 21

The method of embodiment 18, 19 or 20 wherein the first material is amorphous.

### Embodiment 22

The method of embodiment 18, 19 or 20 wherein the first material is crystalline.

### Embodiment 23

The method of embodiment 18, 19 or 20 wherein the fiber is a self-contained fiber.

### Embodiment 24

A method of making at least one self-degrading fiber comprising:
a) providing a first material;
b) providing a second material;
c) combining the first material and the second material in an extruder;
d) heating the mixture of the first material and the second material; and
e) extruding the mixture through a die head to form a fiber, wherein the fiber has a degradation level of at least 5 weight percent based on the total weight of the fiber when subjected to a temperature of about 38° C. for seven days in the presence of moisture.

### Embodiment 25

A method of making at least one self-degrading fiber comprising:
a) providing a first material;
b) providing a second material;
c) combining the first material and the second material in an extruder;
d) heating the mixture of the first material and the second material; and
e) extruding the mixture through a die head to form a fiber, wherein the fiber has a degradation level of at least 5 weight percent based on the total weight of the fiber when subjected to a temperature of about 49° C. for seven days in the presence of moisture.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

These abbreviations are used in the following examples: g=gram, min=minutes, in=inch, m=meter, cm=centimeter, mm=millimeter, ml=milliliter, and mmHg=millimeters of mercury.

The following materials were used in Examples 1-9:

### First Material:

“PLA 4060”: amorphous polylactic acid commercially available from NatureWorks, Minnetonka, Minn.
“PLA 4032”: crystalline polylactic acid commercially available from NatureWorks “PLA 6202”: polylactic acid (PLA) commercially available from NatureWorks

### Second Material:

Oligomeric copolymer of lactic and glycolic acids (75/25) (OLGA) prepared according to the following description: approximately 106.2 g of an aqueous solution of lactic acid (commercially available from ADM, Decatur, Ill.) and 37.6 g of glycolic acid (commercially available from DuPont, Wilmington, Del.) were added to a 250 ml reactor. Approximately 24 g of water was distilled off at a temperature of 55° C. and vacuum of 50 mmHg. After, the batch temperature was risen to 125° C. and the reaction was kept under these conditions 4 hours. Nitrogen was purged into the mixture and a sample was drawn out for titration with 0.5 N Potassium Hydroxide (KOH) in methanol. When a titration value of 350 g/equivalent was reached, the reaction was stopped and the OLGA material was removed from the reactor.

Copolymer of 2-ethylhexyl acrylate (2-EHA) and dimethylamino ethylmethacrylate (DMAEMA) prepared according to the following description: in a glass flask the following raw materials were charged: 0.15 grams of an antioxidant commercially available under the trade designation “IRGANOX 1010” (from Ciba Specialty Chemicals Tarrytown, N.Y.); 38.4 grams of 2-EHA (commercially available from BASF Ludwigschaffen, Germany); 60 grams of DMAEMA (commercially available from BASF); 1.5 grams of mercapto propanediol (Sigma-Aldrich St. Louis, Mo.); and 1.62 grams of a mixture of 1 gram of a polymerization initiator (commercially available under the trade designation “VAZO 52” from DuPont) in 80 grams 2-EHA. The raw materials were mixed, purged using nitrogen and subsequently heated to 60° C. The reaction exothermed to 117° C. and was cooled to room temperature. To the mixture were added: 0.7 grams of a mixture of 2.5 grams of “VAZO 52”, 1.5 grams of a second initiator available under the trade designation“VAZO 67” (from DuPont), 1.5 grams of a third initiator commercially available under the trade designation “VAZO 88” (from DuPont) and 1.5 grams of a fourth initiator commercially available under the trade designation “LUPERSOL 101” (from Atofina Chemicals, Philadelphia, Pa.) in 43 grams of ethyl acetate (available from EMD Chemicals, Gibbstown, N.J.). The mixture was purged using nitrogen and then heated to 60° C. The reaction exothermed to 160° C. and was held at that temperature for 1.5 hours. Vacuum was applied for one hour to remove volatiles and the product was then drained.

“JEFFAMINE D2000”: amine terminated polypropylene glycol commercially available from Huntsman Chemical, Salt Lake City, Utah.

DL-Lactide (lactide): 3,6-dimethyl-1,4-dioxane-2,5-dione commercially available from Aldrich Chemical, St. Louis, Mo.

“PEG 400”: polyethylene glycol commercially available from Alfa Aesar, Ward Hill, Mass.

### Comparative Example 1

Degradable pellets were prepared by blending first and second materials JEFFAMINE in a 25 mm twin screw extruder (model “Ultraglide” commercially available from Berstorff, Hannover, Germany). Pellets of PLA 4060 (first material) were dried overnight at a drying temperature of 105° F. (41° C.) and subsequently blended with JEFFAMINE D2000 (second material) on a 96/4 by weight ratio in the twin screw extruder. The twin screw extruder was heated to about 190-230° C. A molten strand of degradable material was drawn through cold water and cut into cylindrical pellets. The degradable pellets were dried overnight at 105° F. (41° C.) under vacuum.

A degradable fiber (comparative example 1) was prepared by adding degradable pellets into a 19 mm single screw extruder (commercially available from Killion Laboratories, Houston, Tex.). The single screw extruder was equipped with a 0.02 in (0.05 cm) diameter die having a 64-filament orifice and 4:1 length/diameter ratio. The die and single screw extruder were heated to 150-170° C. The fibers were air cooled and drawn at a roll speed of 250 m/min. The number average diameter of the resulting fibers was in the range of 0.020 mm to 0.025 mm.

### Comparative Example 2

Degradable pellets were prepared as described in Comparative Example 1, except that lactide was used as a second material, and the twin screw extruder was heated to about 190° C.-230° C. Pellets of PLA 4060 and lactide were added to the twin screw extruder on a 95/5 by weight ratio. A degradable fiber (comparative example 2) was prepared as described in Comparative Example 1.

### Comparative Example 3

A 100% PLA degradable fiber (comparative example 3) was prepared as described in Comparative Example 1, except that there was no second material, and PLA 6202 was used. Pellets of PLA 6202 were dried overnight at 170° F. (77° C.) and subsequently added to the single screw extruder to form the degradable fiber.

### Examples 1-4

The following description was used in Examples 1 to 4: Self-degrading pellets were prepared by blending first and second materials as described in Comparative Example 1, except that OLGA was used as a second material. Two polylactic acids were used at varying weight ratios. Prior to blending the first and second materials, the pellets of polylactic acid were dried overnight at a drying temperature of 105° F. (41° C.) for PLA 4060, and 170° F. (77° C.) for PLA 4032. The dried pellets of polylactic acid were then blended with the second material in the twin screw extruder to form self-degrading pellets. Self-degrading pellets were dried in vacuum overnight at 41° C. for PLA 4060 and 77° C. for PLA 4032 prior to being fed into the single screw extruder to form self-degrading fibers. Temperatures of the twin screw extruder and single screw extruder were also adjusted according to the composition. Composition and process conditions of self-degrading fibers of Examples 1 to 4 are shown in Table 1, below.

TABLE 1
Composition and process conditions.

| | | | Temperature range | |
|---|---|---|---|---|
| | | PLA/OLGA | Twin screw | Single screw |
| Example | PLA | weight ratio | extruder (° C.) | extruder (° C.) |
| Example 1 | PLA 4060 | 95/5 | 190-230 | 150-170 |
| Example 2 | PLA 4060 | 90/10 | 190-230 | 130-165 |
| Example 3 | PLA 4060 | 80/20 | 190-230 | 120-165 |
| Example 4 | PLA 4032 | 90/10 | 185-230 | 120-145 |
| Example 5 | PLA 4032 | 80/20 | 185-230 | 120-160 |

### Example 6

Self-degrading pellets were prepared as described in Comparative Example 1, except that OLGA and polyethylene glycol were used as second materials. PLA 4060, OLGA and PEG 400 were added on an 80/10/10 weight ratio in the twin screw extruder heated to about 185° C.-230° C. A self-degrading fiber (example 6) was prepared using the single screw extruder heated to 120° C.-145° C.

Glass transition temperature (Tg) was measured for each fiber using differential scanning calorimetry (model “DSC Q2000” commercially available from TA Instruments, Newcastle, Del.) at a temperature increase rate of 10° C./min. Tg is reported in Table 2, below.

### Example 7

A self-degrading fiber was prepared as described in Comparative Example 1, except that the copolymer of 2-EHA/DMAEMA was used as a second material. The weight ratio of PLA 4060 (first material) and the copolymer of 2-EHA/DMAEMA was 90/10.

### Example 8

A self-degrading fiber was prepared as described in Example 7, except that PLA 4032 was used as the first material. The weight ratio of first and second materials was 90/10.

Degradation rate of fibers prepared as described in Comparative Examples 1 to 3 and Examples 1 to 8 was measured at different temperatures for seven days. To separate containers, approximately 0.5 grams of each fiber and 100 grams of deionized (DI) water were added. The containers were shaken to homogenize the dispersion and subsequently placed in a convection oven set at a testing temperature of about 38° C. for seven days. After, water was drained from the containers through a glass frit filter (using a porosity C fritted disk with 25-50 micron pore size commercially available from Ace Glass Company, Inc. Vineland, N.J.) and the fibers were dried at 50° C. overnight (approximately 16 hours). The fibers were removed from the oven and allowed to cool at room ambient conditions before being weighed. Percent weight loss was then calculated. The procedure was repeated for testing temperatures of 49° C. and 71° C. Percent weight loss for Comparative Examples 1 to 3 and Examples 1 to 8 at different temperatures is shown in Table 2, below.

TABLE 2
Tg and percent weight loss at different temperatures.

| | | Percent weight loss | | |
|---|---|---|---|---|
| Examples | Tg (° C.) | At 38° C. | At 49° C. | At 71° C. |
| Comparative Example 1 | 44.3 | 1.61 | 2.89 | 49.94 |
| Comparative Example 2 | 50.7 | 2.16 | 4.09 | 53.26 |
| Comparative Example 3 | 62.7 | 4.20 | 4.88 | 6.14 |
| Example 1 | 54.2 | 5.09 | 6.89 | 51.69 |
| Example 2 | 49.5 | 8.23 | 11.32 | 62.54 |
| Example 3 | 38.6 | 11.45 | 17.8 | 70.05 |
| Example 4 | 52.8 | 8.30 | 9.80 | 19.70 |
| Example 5 | 41.3 | 15.11 | 21.22 | 31.95 |
| Example 6 | 22.5 | 12.93 | 16.66 | 34.54 |
| Example 7 | 54 | 9.28 | 11.91 | 35.53 |
| Example 8 | not | 5.95 | 8.48 | 15.38 |
| | measured | | | |

Crystallinity content of the PLA affected weight loss at higher temperatures (e.g. 71° C.); however degradation at 38° C. and 49° C. was comparable for both crystalline and amorphous PLA when compounded with a second material (e.g. OLGA) on a 90/10 weight ratio. Varying the amount of the second material resulted in different degradation rates of the self-degrading fiber at lower and higher temperatures. In general, higher amounts of the second material resulted in an increase in the degradation level of the self-degrading fiber. Nonetheless, higher amounts of the second material increase the melt flow index of the polymer, therefore there is a limit to the amount of second material that may be incorporated into the self-degrading fiber. Melt flow indices adequate to form self-degrading fibers are equal to or higher than 8 g/10 min.

Neither lactide nor JEFFAMINE D2000 produced self-degrading fibers with degradation levels of at least 5% after seven days at 38° C. and/or 49° C. Degradation levels of the self-degrading fibers according to the present disclosure are significantly higher than that of Comparative Examples 1 and 2, in which lactide and JEFFAMINE D2000 were used as second materials. Degradation levels of fibers according to the present disclosure are also significantly higher than that of 100% PLA fibers, as shown in comparative example 3.

Various modifications and alterations of this invention will become apparent to those skilled in the art without departing from the scope and spirit of this invention.

What is claimed is:

1. A self-degrading fiber comprising:
(a) from about 60 weight percent to about 96 weight percent of a first material based on the total weight of the fiber, and
(b) from about 4 weight percent to about 40 weight percent of a second material based on the total weight of the fiber,
wherein the second material is selected at least one of an oligomer comprising lactate and glycolate and a copolymer of 2-ethylhexyl acrylate and dimethylamino ethylmethacrylate.

2. The self-degrading fiber of claim 1 further comprising:
(c) a plasticizer.

3. The self-degrading fiber of claim 2 wherein the plasticizer is selected from polyethylene glycol, starch, glucose, polypropylene glycol, and combinations thereof.

4. The self-degrading fiber of claim 1 wherein the first material comprises at least about 70 weight percent and the second material comprises no more than 30 weight percent based on the total weight of the fiber.

5. The self-degrading fiber of claim 1 wherein the second material comprises at up to 75 weight percent of lactate and at least 25 weight percent of glycolate.

6. The self-degrading fiber of claim 1 wherein the first material is amorphous.

7. The self-degrading fiber of claim 1 wherein the first material is crystalline.

8. The self-degrading fiber of claim 1 wherein the first material is a mixture of crystalline and amorphous.

9. The self-degrading fiber of claim 1 wherein the fiber is a self-contained fiber.

10. A self-degrading fiber comprising a first material and a second material, wherein the fiber has a degradation level of at least 5 weight percent based on the total weight of the fiber when subjected to a temperature of about 38° C. for seven days in the presence of moisture.

11. The self-degrading fiber of claim 10 wherein the second material further comprises polyethylene glycol.

12. The self-degrading fiber of claim 10 wherein the first material is amorphous.

13. The self-degrading fiber of claim 10 wherein the first material is crystalline.

14. A self-degrading fiber comprising a first material and a second material, wherein the fiber has a degradation level of at least 5 weight percent based on the total weight of the fiber when subjected to a temperature of about 49° C. for seven days in the presence of moisture.

15. The self-degrading fiber of claim 14 wherein the second material further comprises polyethylene glycol.

16. The self-degrading fiber of claim 14 wherein the first material is amorphous.

17. The self-degrading fiber of claim 14 wherein the first material is crystalline.

18. A method of making at least one self-degrading fiber comprising:
a) providing from about 70 weight percent to about 96 weight percent of a first material;
b) providing from about 4 weight percent to about 30 weight percent of a second material, wherein the second material is selected from at least one of an oligomer comprising lactic acid and glycolic acid and a copolymer of 2-ethylhexyl acrylate and dimethylamino ethylmethacrylate;
c) combining the first material and the second material in an extruder;
d) heating the mixture of the first material and the second material; and
e) extruding the mixture through a die head to form a fiber.

19. The method of claim 18 wherein the second material further comprises polyethylene glycol.

20. The method of claim 18 wherein the second material comprises at least 75 weight percent of lactic acid and at least 25 weight percent of glycolic acid.

21. The method of claim 18 wherein the first material is amorphous.

22. The method of claim 18 wherein the first material is crystalline.

23. The method of claim 18 wherein the fiber is a self-contained fiber.

24. A method of making at least one self-degrading fiber comprising:
a) providing a first material;
b) providing a second material;
c) combining the first material and the second material in an extruder;
d) heating the mixture of the first material and the second material; and
e) extruding the mixture through a die head to form a fiber, wherein the fiber has a degradation level of at least 5 weight percent based on the total weight of the fiber when subjected to a temperature of about 38° C. for seven days in the presence of moisture.

25. A method of making at least one self-degrading fiber comprising:
a) providing a first material;
b) providing a second material;
c) combining the first material and the second material in an extruder;
d) heating the mixture of the first material and the second material; and
e) extruding the mixture through a die head to form a fiber, wherein the fiber has a degradation level of at least 5 weight percent based on the total weight of the fiber when subjected to a temperature of about 49° C. for seven days in the presence of moisture.
